(19) United States
(12) Patent Application Publication
(10) Pub. No.: US 2022/0324143 A1
(43) Pub. Date: Oct. 13, 2022

(54) PLASTICIZING UNIT FOR A SHAPING MACHINE AND METHOD FOR OPERATING ONE

(71) Applicant: ENGEL AUSTRIA GmbH, Schwertberg (AT)

(72) Inventors: Guenther KLAMMER, Aschbach Markt (AT); Klaus FELLNER, Steyr (AT)

(21) Appl. No.: 17/702,335

(22) Filed: Mar. 23, 2022

(30) Foreign Application Priority Data
Apr. 7, 2021 (AT) A 50252/2021

(51) Int. Cl. B29C 45/17; B29C 45/50; B29C 45/77

(52) U.S. Cl. CPC B29C 45/1753; B29C 45/5008; B29C 45/77; B29C 2045/5088; B29C 2945/76498; B29C 2945/76665

(57) ABSTRACT

Plasticizing unit for a moulding machine having at least one plasticizing screw for plasticizing a plasticizable material and injecting it into at least one mould cavity, which at least one plasticizing screw is rotationally and axially movable in relation to a screw axis, wherein at least one filter is provided, which is arranged downstream of the at least one plasticizing screw in a direction of flow of a mass flow of the plasticizable material.

The present invention relates to a plasticizing unit for a moulding machine having the features of the preamble of claim 1, a moulding machine having at least one such plasticizing unit as well as a method of operating a plasticizing unit for a moulding machine having the features of the preamble of claim 18.

By moulding machines may be meant injection-moulding machines, transfer-moulding presses, presses and the like. Moulding machines in which the plasticized mass is fed to an open mould are also entirely conceivable.

The state of the art will be outlined below with reference to an injection-moulding machine. The same applies to moulding machines in general.

Generic plasticizing units for moulding machines comprise at least one plasticizing screw for plasticizing a plasticizable material and injecting it into at least one mould cavity, which at least one plasticizing screw is arranged in a rotationally and axially movable manner in relation to a screw axis.

Corresponding plasticizing units are used in injection-moulding machines to plasticize a plasticizable material by a rotary movement of the at least one plasticizing screw, wherein the plasticizable material is plasticized by shear energy, shear heat and possibly externally supplied thermal energy.

After the material to be plasticized has been plasticized, the plasticized material to be plasticized can be pushed out of the plasticizing unit by an axial movement of the at least one plasticizing screw and injected into a mould cavity of a mould, in which the plasticized material can harden again (and can thus, for example, set as a finished product, moulded part or semi-finished product).

It is known from the state of the art to process contaminated plastics as a material to be plasticized. These plastics can be e.g. recyclates, ground materials or agglomerates, which are used for example in a recycling or compounding application.

This topic is becoming increasingly important, wherein, through the recycling of materials to be plasticized (for example thermoplastics), these can be supplied to a new use or a new area of application, and a distinct advantage with regard to environmental friendliness can thus be created.

However, in order to be able to use such recycled materials again in an injection-moulding process, it is first necessary to clean them, wherein the contaminants are to be removed from the mass to be plasticized.

For this cleaning and/or precleaning of the materials to be plasticized, it is known to plasticize them in a first step using a continuously operating plasticizing unit and then to clean them using degassing processes and filter systems. After filtration and degassing, the plasticized material is cooled and set again, wherein the cleaned material is usually brought directly into a form that is easy to process further, such as for example pellets, wherein the pellets can be fed directly to an injection-moulding machine in a subsequent injection-moulding process.

However, a disadvantage of this has proved to be that it is relatively energy- and labour-intensive to clean this material and prepare it for an injection-moulding process.

The object of the invention is therefore to provide a plasticizing unit and/or a method of operating a plasticizing unit in which the disadvantages of the state of the art can be at least partially improved and/or a more energy-efficient recycling of plasticizable materials can be implemented and/or a more energy-efficient cleaning of materials to be plasticized is possible and/or a direct processing of materials to be plasticized to be cleaned is made possible.

This object is achieved by a plasticizing unit for a moulding machine having the features of claim 1, a moulding machine having at least one such plasticizing unit, as well as a method of operating a plasticizing unit for a moulding machine having the features of claim 18.

It is provided according to the invention that a plasticizing unit for a moulding machine has at least one plasticizing screw for plasticizing a plasticizable material and injecting it into at least one mould cavity, wherein at least one plasticizing screw is rotationally and axially movable in relation to a screw axis, wherein at least one filter is provided, which is arranged downstream of the at least one plasticizing screw in a direction of flow of a mass flow of the plasticizable material.

Through the arrangement of at least one filter after the axially movable at least one plasticizing screw in the direction of flow of the plasticizable material, a plasticized material from the at least one plasticizing screw can be easily cleaned of contaminants.

Contaminated materials, as used for example in the recycling process, can thus be used for example in existing injection-moulding machines, wherein the plasticizing unit of the injection-moulding machine is utilized for plasticizing the contaminated material and the contaminants (before injection into a mould cavity) can then be filtered by at least one filter after the at least one plasticizing screw in the direction of flow of the mass flow of the plasticizable material. The same applies to moulding machines in general.

By moulding machines may be meant injection-moulding machines, transfer-moulding presses, presses and the like. Moulding machines in which the plasticized mass is fed to an open mould are also entirely conceivable.

It should be mentioned that moulding machines having at least one plasticizing screw which are axially and rotationally movable usually operate in cycles, wherein the plasticizable material is first plasticized by the rotating movement and then injected into a mould cavity or the like by an axial movement.

Because of the filtering of the plasticizable mass directly in cycles—i.e. discontinuously—operating moulding process, it is possible to cut down on the steps described at the beginning (such as for example granule production), which is obviously a significant improvement with regard to complexity and economic efficiency.

It is thus no longer necessary to use an additional process to process the plasticizable material beforehand by a filtration or cleaning. Thus the actual moulding process in the moulding machine can now be utilized to carry out a preparation of the material to be plasticized, whereby the energy efficiency for processing the plasticizable material (for example recycling material) is reduced and/or the processing effort for cleaning a plasticizable material is reduced and/or the production costs and thus also the product costs of a subsequently produced moulding part are reduced.

Thus, through a corresponding application of an embodiment variant of the present invention, a recycling application or compounding application can be designed considerably more attractive to a user, wherein the production costs and the production effort are minimized, whereby the environmental friendliness can be increased (through more widespread application).

A plasticizing unit according to the invention can have precisely one plasticizing screw or also can be formed as a twin-screw or multi-screw embodiment. Reference is sometimes made in the following description to the plasticizing screw (singular). However, this is to be understood such that analogous embodiments with several plasticizing screws equally apply.

In embodiments with several plasticizing screws, there will of course be several screw axes, in relation to which the plasticizing screws are in each case axially and rotationally movable.

A device according to the invention or a method according to the invention can find a use and be installed subsequently by being used in already known embodiment variants of the state of the art, as described for example in the introductory part of the description.

Advantageous embodiments are defined with the aid of the dependent claims.

It can preferably be provided that a filter-changing device is provided, which is formed to move the at least one filter out of the mass flow of the plasticizable material by a first linear movement and/or rotary movement and/or to move the at least one filter into the mass flow of the plasticizable material by a second linear movement and/or rotary movement.

The filter-changing device can thus be provided to move the at least one filter out of the mass flow of the plasticizable material, for example when there are contaminants or displacements, in order to free it of contaminants which have been captured by the at least one filter, wherein it can be provided that the filter-changing device then moves the cleaned at least one filter back into the mass flow of the plasticizable material.

While such a cleaning of the at least one filter is taking place, it can be provided that at least one further filter is moved into the mass flow of the plasticizable material by the filter-changing device, with the result that at least two filters are in the mass flow of the plasticizable material alternately and the production process of the plasticizing unit need not be interrupted.

The filter-changing device can be formed, for example, as a slide-plate screen changer, piston screen changer, cassette screen changer and/or belt filter.

When a belt filter is provided as the filter-changing device, it can be provided that the belt filter is passed continuously or at intervals through the mass flow of the plasticizable material, wherein displaced filter regions or contaminants of the at least one filter can be moved by the filter-changing device out of the mass flow of the material to be plasticized in order not to impair the ongoing process of the plasticizing unit.

The inward and/or outward movement of the at least one filter can take place for example in an operating condition of the plasticizing unit in which a mass flow of plasticizable material is not actively pushed out by the at least one plasticizing screw, with the result that no active pressure resulting from a mass flow of the plasticizable material acts on the at least one filter during the inward and/or outward movement by the filter-changing device.

It can be provided that at least one actuator is provided for conveying the plasticizable material against the direction of flow of the mass flow in order to effect a pressure relief of a pressure of the plasticizable material bearing on the at least one filter.

It can preferably be provided that at least one actuator and an open- or closed-loop control unit for activating the actuator are provided, wherein the open- or closed-loop control unit is formed to activate the actuator to such an extent that the mass flow of the plasticizable material is conveyed against the direction of flow in order to effect a pressure relief of a pressure of the plasticizable material bearing on the at least one filter.

A corresponding embodiment variant can create the possibility of influencing pressure conditions prevailing on the at least one filter (which act on the at least one filter as a result of the plasticized mass) by utilizing the at least one actuator such that a pressure relief of the at least one filter—which can be utilized for example for a filter change—can be carried out. This is preferably possible without an additional shut-off (for example using a shut-off valve) of the filter from the mass flow of the material to be plasticized.

By a pressure relief may be meant within the meaning of the present document a relief of significant pressures on the at least one filter. Thus, by a pressure relief may also be meant a load relief of the at least one filter when an approximately equally high pressure is being exerted on the at least one filter from both sides.

In other words, it is characteristic of the pressure relief that forces acting on the filter—preferably as a result of the plasticized material (especially in the direction of flow of the mass flow)—can be reduced at least far enough to decrease the loads on the at least one filter enough that the at least one filter can be changed (and preferably no damage to the at least one filter and/or the plasticizing unit occurs when the at least one filter is changed).

It is preferably provided that the at least one actuator is formed by the at least one plasticizing screw and/or by a piston/cylinder unit preferably in the form of a melt accumulator.

It can be provided that the piston/cylinder unit is arranged fluidically between the at least one filter and the plasticizing screw or is arranged fluidically after the at least one filter.

In embodiments wherein the at least one plasticizing screw plays the part of an actuator, a pressure relief and/or backflushing of the at least one filter can therefore be carried out by an axial movement of the at least one plasticizing screw against the direction of flow of the material to be plasticized.

It is preferably provided that an open- or closed-loop control unit for activating the actuator and the filter-changing device is provided, which is formed to activate the actuator to pull back against the direction of flow of the plasticizable material in order to effect a pressure relief of a pressure of the plasticizable material bearing on the at least one filter and/or a backflushing of the at least one filter.

The open- or closed-loop control unit can be arranged directly on the plasticizing unit or the moulding machine. Alternatively, it can also be arranged remotely from the moulding machine or the plasticizing unit and connected to various elements of the plasticizing unit via a remote data transmission link, for example in the form of a server linked in such a way.

The remote data transmission link can be implemented by means of a LAN (local area network), WLAN (wireless local area network), WAN (wide area network) and/or various (Internet) protocols—preferably OPC UA (Open Platform Communications Unified Architecture).

Finally, the open- or closed-loop control unit can also be implemented by distributed computing, i.e. the functions of the open- or closed-loop control unit are then implemented by a plurality of computing processes which can run on various computers regardless of the position of the moulding machine or of the plasticizing unit.

Thus, for example, it can be provided that at least one plasticizing screw is activated for pressure relief via the open- or closed-loop control unit to such an extent that it is moved in the axial direction against the direction of flow of the mass flow of the plasticizable material through the at least one filter, with the result that at least a temporary pressure relief of the at least one filter is produced.

It can be provided that the open- or closed-loop control unit is formed to activate the filter-changing device during the pressure relief to move the at least one filter out of the mass flow of the plasticizable material and/or to move the at least one filter into the mass flow of the material to be plasticized.

The open- or closed-loop control unit could also be formed, when the filter-changing device is provided as a belt filter, in order that the pressure relief of the at least one filter takes place while the belt filter is activated, in order to move it through the region of filtration of the mass flow of the plasticizable material.

It can preferably be provided that at least one removal device is provided, with which plasticizable material present between at least one plasticizing screw and at least one filter is at least partially removable.

Through the removal device, it can be provided that a plasticizable material present between the at least one plasticizing screw and the at least one filter, which contains increased contaminants due to the filtration by the at least one filter, can be removed.

These contaminants between the at least one plasticizing screw and at least one filter can arise as a result of the filtration by the filter, wherein they can be released from the filter, for example by a scraper or similar, and then removed via the at least one removal device.

However, an embodiment is also conceivable in which, in the course of the pressure relief by the at least one actuator, the mass flow of the plasticizable material is drawn back through the at least one filter, whereby a backflushing of the at least one filter can be performed. In order then to be able to remove the contaminants of the filter, which have been released from the at least one filter by the backflushing, the at least one removal device can be utilized.

It can be provided that a pressure relief and/or a backflushing of the at least one filter is achieved by a pressure prevailing after the at least one filter in the direction of flow of the material to be plasticized. Thus, for example, an applied pressure before the at least one filter in the direction of flow can be relieved (for example by load relief of the at least one plasticizing screw) and a backflushing through the at least one filter can be induced via a pressure prevailing after the at least one filter in the direction of flow (via the pressure gradient induced), wherein a subsequent pressure relief of the at least one filter occurs.

It can be provided, for example, that the at least one removal device has at least one discharge screw, at least one piston/cylinder unit and/or at least one outlet valve, via which a plasticized mass can be removed between at least one plasticizing screw and at least one filter.

Thus, for example, via a discharge screw or a piston/cylinder unit, a plasticized mass can be actively removed from a mass flow-way between at least one plasticizing screw and at least one filter because the discharge screw and/or the piston/cylinder unit actively conveys this plasticized mass.

However, it can also be provided that a mass flow-way has an outlet valve between at least one plasticizing screw and at least one filter, whereby the plasticized mass can be diverted in its direction of flow and thus removed. Such an outlet valve can be designed as a two-way valve, for example. In order to improve the mass flow of the plasticized melt, however, it can also be provided that the at least one filter is shut off by a shut-off valve while the outlet valve is opened, with the result that the mass flow of plasticized mass can only escape from the at least one plasticizing screw via the outlet valve. Embodiments with three-way valves are also conceivable.

It is preferably provided that the open- or closed-loop control unit is formed to remove a mass flow of the plasticizable material present between the at least one filter and the at least one plasticizing screw during the pressure relief by activating the at least one removal device.

It can be provided that a manifold is arranged after the at least one plasticizing screw and before the at least one filter in a direction of flow of the mass flow of the plasticizable material.

Particularly preferably, the manifold can be designed such that similar conditions with respect to the mass flow and with respect to the pressure are obtained in the various channels/branches of the manifold. In other words, the manifold can be used to distribute the pressure exerted by the mass flow of the plasticizable material onto one or more filters as homogeneously as possible. Such a manifold is referred to for the purposes of the invention as a “pressure manifold”.

Through the provision of a manifold—preferably a pressure manifold—it can be provided that the mass flow of the plasticizable material is distributed evenly within a filter over the entire surface of the filter, or also that a mass flow of at least one plasticizing screw is distributed onto several filters.

It is preferably provided that the at least one filter has a screen and/or a woven fabric and/or a perforated filter unit. However, other filter units known from the state of the art for filtering a plasticized mass are also conceivable.

For example, an embodiment of the at least one filter which comprise perforated regions of a barrier (for example in the form of a metal sheet) is conceivable. In addition, in such an embodiment, non-perforated regions and/or non-perforated sub-regions of the barrier could be provided in an edge region of the at least one filter (viewed in the direction of flow of the mass flow of the material to be plasticized). These non-perforated regions and/or non-perforated sub-regions of the barrier in an edge region of the at least one filter can be utilized to improve the sealing of the at least one filter against an environment.

It can be provided that at least one scraping device is provided for scraping the at least one filter.

Through at least one scraping device, it can be provided that the at least one filter is scraped regularly or as required in order to release contaminants from the at least one filter in order to be able to ensure a continuous, constant functionality and efficacy of the at least one filter.

It can be provided that the at least one scraping device is formed movable by an active drive device and can thus move relative to the at least one filter. However, an embodiment is also conceivable in which the at least one scraping device is not actively drivable but the at least one filter is arranged so as to be movable relative to the scraping device, wherein the at least one filter can be moved past the scraping device by movement of the at least one filter.

For example, it could thus be provided that the at least one filter is formed movable by the filter-changing device, which filter can be moved past the scraping device when the at least one filter moves into or out of the mass flow of the plasticizable mass, wherein deposits on the at least one filter are preferably scraped off by the scraping device.

It can be provided that at least one seal is provided for sealing the at least one filter. It is preferably provided that the at least one seal is pressed into a sealing position by the mass flow of material to be plasticized, wherein in the sealing position the at least one seal seals the at least one filter against an environment (and thus for example an uncontrolled leakage of part of the mass flow is prevented).

It can thus be provided that the load on the at least one seal is relieved by a pressure relief and/or backflushing, whereby a filter change of the at least one filter is made possible (without damaging the at least one seal).

It can be provided that at least one dosing device for additives—preferably at least one gas injector—is arranged before the at least one filter in a direction of flow of the mass flow of the plasticizable material.

It can particularly preferably be provided that the at least one dosing device for additives is provided at the at least one plasticizing screw in a direction of flow of the mass flow of the plasticizable material, wherein an additive can be supplied to the plasticized mass, the plasticizable material and/or during a transition of the plasticizable material into a plasticized mass.

On the one hand, these additives can act as a flow aid to reduce the pressure on the at least one filter, and thus to be able to operate more gently. Damage to the at least one filter is thus prevented.

Furthermore, as a rule, filters have to be replaced after a certain period because they fill up with the dirt particles to be filtered. This dirt build-up becomes apparent in the increasing pressure drop at the at least one filter. Too great a pressure drop damages the at least one filter. The period between filter changes can therefore be lengthened by adding an additive (for example a flow aid).

The added additives can subsequently remain in the plasticized mass and thus serve various purposes in the subsequent product of the plasticized mass (a plastics component).

Physically acting additives (such as for example the addition of gas via injectors on the plasticizing cylinder) or also the addition of chemical blowing agents are both conceivable. These can be used for example for foaming a product and thus for reducing weight.

Other chemically acting additives are also conceivable, for example additives for adjusting the polymer chain length and thus the properties associated therewith, primarily the flowability.

Peroxides in the case of PP (polypropylene) or also glycols in the case of PET (polyethylene terephthalate) may be mentioned here for example. However, other reagents are of course also conceivable.

In both cases, for example, better filling of a moulding tool or better flow through the at least one filter is possible owing to the higher flowability.

It can therefore advantageously be provided that the additives (preferably additives that are needed anyway in the case of a moulding machine) are already added before the filter.

Protection is furthermore sought for a moulding machine—in particular an injection-moulding machine—having at least one plasticizing unit according to the present invention.

Protection is likewise sought for a method of operating a plasticizing unit, wherein a plasticizable material is plasticized by a rotating movement of at least one plasticizing screw in relation to a screw axis and the plasticizable material is injected into at least one mould cavity by an axial movement of the at least one plasticizing screw in relation to the screw axis, wherein the mass flow of the plasticizable material is filtered with the aid of at least one filter, which is arranged downstream of the at least one plasticizing screw in a direction of flow of a mass flow of the plasticizable material.

This is not a chronological recital of the method steps. In fact, for example, the rotating movement, the injection and the filtration will in reality have a temporal overlap. In other words, these method steps do not necessarily have to be carried out in the stated order and thus are also not to be limited to the stated order thereof.

It is preferably provided that the mass flow of the plasticizable material is conveyed against the direction of flow by means of at least one actuator—preferably the at least one plasticizing screw—and thus a pressure relief of a pressure of the plasticizable material bearing on the at least one filter is effected.

It can be provided that the at least one filter is moved out of and/or into the mass flow of the plasticizable material via a filter-changing device during the pressure relief.

Further advantages and details of the invention follow from the figures as well as the associated description of the figures. There are shown in:

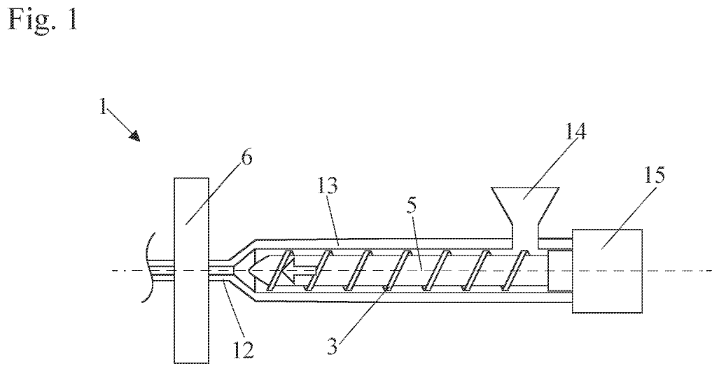

FIG. 1 a first embodiment example according to the invention of a plasticizing unit,

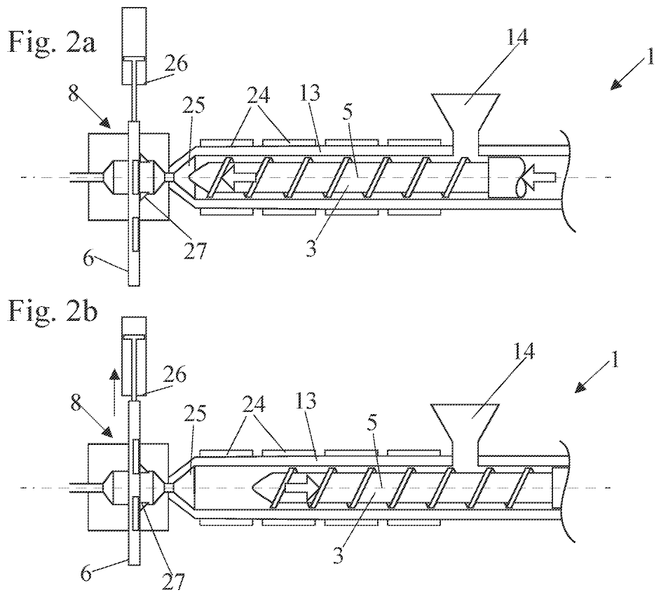

FIGS. 2a, 2b a filter-changing device for a plasticizing unit,

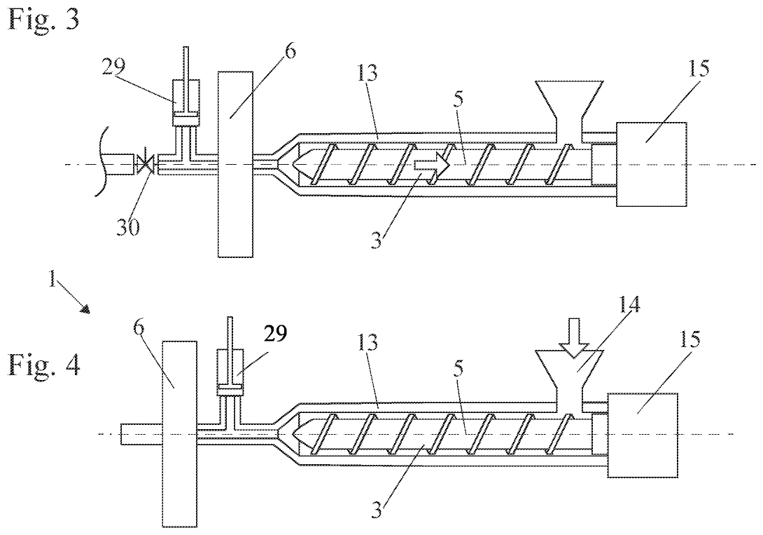

FIG. 3 a further embodiment example of a plasticizing unit,

FIG. 4 an alternative embodiment of a plasticizing unit,

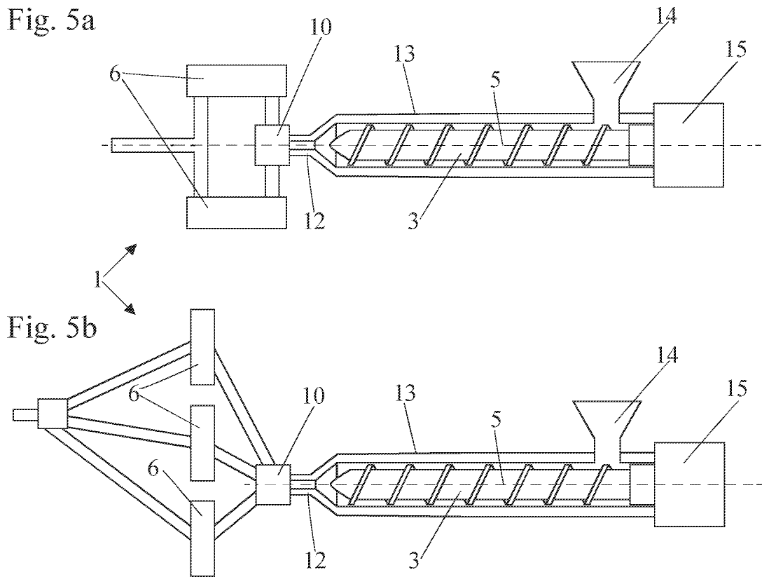

FIGS. 5a, 5b embodiment variants of a plasticizing unit with several filters,

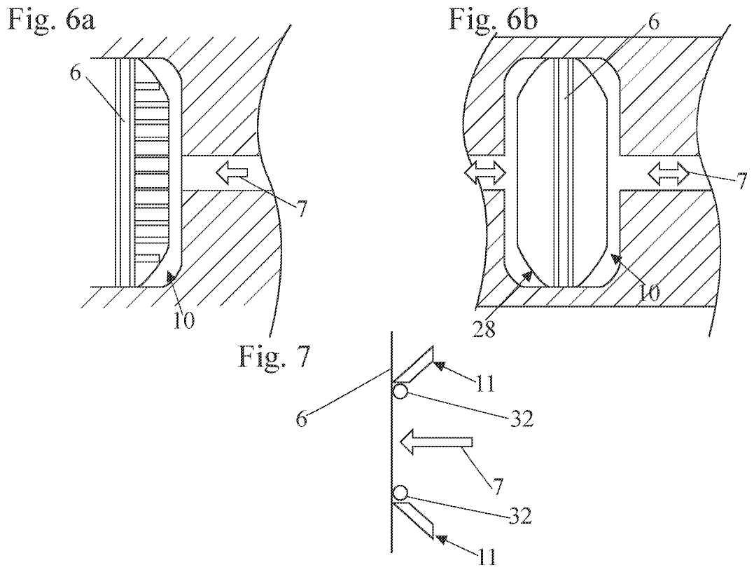

FIGS. 6a, 6b the provision of a manifold in a filter,

FIG. 7 an embodiment example of a scraping device, and

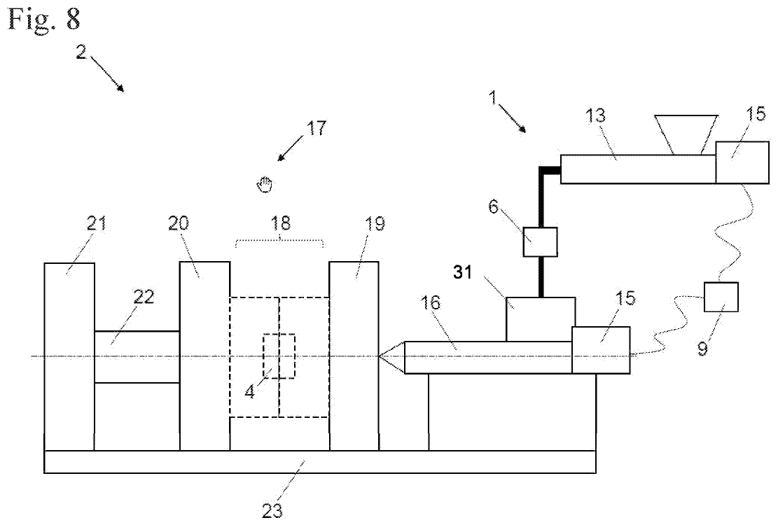

FIG. 8 a moulding machine with a plasticizing unit.

FIG. 1 shows a first embodiment example according to the invention of a plasticizing unit 1 for a moulding machine 2.

The plasticizing unit 1 has a plasticizing screw 3, which is arranged in a mass cylinder 13. The plasticizing screw 3 is drivable via a drive unit 15, wherein the plasticizing screw 3 is formed to carry out a rotary movement about the screw axis 5 and an axial linear movement along the screw axis 5, which movements can be induced by the drive unit 15.

The drive unit 15 can be controlled or regulated via an open- or closed-loop control unit 9, which open- or closed-loop control unit 9 is not represented in FIG. 1 for reasons of clarity.

Via a feed device 14, a plasticizable material can be fed to the plasticizing screw 3, wherein the plasticizable material can be plasticized by a rotary movement of the plasticizing screw 3 and can be collected in a space in front of the screw 25.

Via a subsequent axial movement of the plasticizing screw 3, the plasticized material can be pushed out of the injection cylinder 13 via the mass flow-way 12, wherein the mass flow 7 of plasticizable material is guided to a filter 6, wherein the mass flow 7 of the plasticized material can be filtered by the filter 6 and thus freed of contaminants before the mass flow 7 of the plasticized material is guided further via the mass flow-way 12 and, for example, fed to a mould cavity 4 of a moulding machine 2.

FIGS. 2a and 2b show a filter-changing device 8 for a plasticizing unit 1.

It can be seen how a material that is plasticizable via the feed device 14 can be plasticized by the plasticizing screw 3 in the mass cylinder 13 by a rotary movement and the resulting shear heat.

This plasticization can additionally be supported by band heaters 24 arranged on the mass cylinder 13, which are formed to introduce additional heat for plasticization into the mass cylinder 13.

The plasticized mass is then collected in the space in front of the screw 25 until, by a linear, axial movement of the plasticizing screw 3 along the screw axis 5, the plasticized mass is pushed out in the form of a mass flow 7 and passed through the filter 6.

In this embodiment example this filter 6 is formed as a slide-plate filter, which can be changed by the filter-changing device 8.

In order to carry out the change of the filter 6, an actuator 26 is provided, as can be seen from FIG. 2a.

In order to carry out a filter change, it can be provided that a pressure relief of the filter 6 is performed by the plasticizing screw 3, as shown by FIG. 2b.

Thus, it can be provided that pressure on the filter 6 is relieved by a linear movement of the plasticizing screw 3 in an axial direction along the screw axis 5 against the direction of flow of the mass flow 7 of the plasticizable material by pulling the mass flow 7 of the plasticizable material causing the pressure prevailing on the filter 6 back into the mass cylinder 12.

As soon as this pressure relief on the filter 6 takes place, it can be provided that the actuator 26 is activated in order to change the filter 6, wherein filter 6 is moved out of the mass flow 7 and a further filter 6 is moved into the mass flow 7 by the movement of the actuator 26.

Such a filter change can be carried out for example by an open- or closed-loop control unit 9, which is formed to control or regulate the plasticizing screw 3 (or the drive unit 15 of the plasticizing screw 3) as well as the filter-changing device 8 (via the actuator 26).

It can be provided that a corresponding filter change, as shown by FIGS. 2a and 2b, is carried out during the ongoing operation of the plasticizing unit 1, wherein the ongoing production process does not have to be stopped especially for a filter change.

Seals 27 are provided in order to seal the filter-changing device 8 against the environment.

It can also be provided that the plasticizing screw 3 is pulled back along its screw axis 5 against the direction of flow of the mass flow 7 of the plasticizable material to a greater extent in order to perform a backflushing of the filter 6, wherein material that has already been plasticized by the filter 6 is pulled back through the filter 6 in order to remove deposits that have accumulated on the filter 6.

In this embodiment example the seal 27 is pressed into a sealing position by the mass flow 7 of material to be plasticized, wherein in the sealing position the seal 7 seals the filter 6 against an environment (and thus an uncontrolled leakage of part of the mass flow 7 is prevented).

The load on the seal 27 can be relieved by a pressure relief and/or a backflushing, whereby a filter change of the filter 6 is made possible without damaging the seal 27.

FIG. 3 shows a further embodiment example of a plasticizing unit 1, wherein a piston/cylinder unit 29 is additionally provided as an actuator for conveying the plasticizable material against the direction of flow of the mass flow 7 in order to carry out a pressure relief of a pressure of the plasticizable material bearing on the filter 6 or a backflushing of the filter 6.

In this embodiment, an already plasticized, filtered material can be pushed back through the filter 6 by the piston/cylinder unit 29 in addition or as an alternative to the plasticizing screw 3.

In order to ensure that the plasticized material is pushed back through the filter 6 by means of the piston/cylinder unit 29, the shut-off valve 30 can be provided, which can be closed for pressure relief or for backflushing of the filter 6 by the piston/cylinder unit 29.

FIG. 4 shows an alternative embodiment of a plasticizing unit, wherein the additional actuator is represented in the form of a piston/cylinder unit 29.

This piston/cylinder unit 29 is arranged downstream of the plasticizing screw 3 in the direction of flow of the mass flow 7 of the plasticizable material and is arranged between plasticizing screw 3 and filter 6.

The piston/cylinder unit 29 of the embodiment example of FIG. 4 can actively carry out a backflushing or can be used in addition, in a supporting manner, to an axial movement of the plasticizing screw 3.

FIGS. 5a and 5b show embodiment variants of a plasticizing unit 1 in which several filters 6 are provided for filtration of a mass flow 7 of plasticized material.

In these embodiment variants, a plasticizable material is again plasticized via a plasticizing screw 3 and fed to a filter 6 via a mass flow-way 12, wherein a manifold 10 is arranged in the mass flow-way 12 between mass cylinder 13 and filters 6 in order to divide the mass flow 7 of the plasticizable material onto the filters 6.

Thus, for example, it can also be provided that the manifold 10 selectively guides the mass flow 7 further to one or more filters 6, whereby the possibility is created that the load on at least one filter 6 is temporarily relieved and the filtration is taken over by the remaining filters 6, with the result that the load-relieved filter 6 can be cleaned or replaced without the plasticizing unit 1 having to interrupt production.

FIGS. 6a and 6b show the provision of a manifold 10, more precisely a pressure manifold, in the application in the case of a filter 6.

Thus, for example, it can be seen in FIG. 6a that a mass flow 7 of plasticizable material is led to the filter 6, wherein the mass flow 7 can be distributed homogeneously over the entire filter 6 via the manifold 10, which is formed by flow-guiding means, with the result that the entire filter cross-section of the filter 6 can be utilized.

The embodiment example shown in FIG. 6a uses a manifold 10 which reduces or enlarges the flow cross-section in corresponding regions of the filter 6 in order to distribute the mass flow 7 as homogeneously as possible over the entire filter 6, for which purpose a flow resistance of the mass flow 7 in the individual channels is adjusted correspondingly.

As can be seen in FIG. 6b, a corresponding manifold 10, more precisely a pressure manifold, can also be arranged on either side of the filter 6 in order also to distribute an incoming mass flow 7 over the entire filter cross-section of the filter 6 during a backflushing of the filter 6.

FIG. 7 shows an embodiment example of a scraping device 11, which can be utilized in order to remove contaminants with the aid of an output device 32, which is preferably formed as a discharge screw.

In this embodiment example these scraping devices 11 of FIG. 7 are formed as positionally stable projections, which abut the filter 6. If the filter 6 is now moved relative to the scraping devices 11, a sharp edge of the scraping devices 11 is passed along the filter surface, which scrape and/or scratch off the deposits and contaminants accumulating on the filter 6.

It could, of course, also be provided that the filter 6 is formed stationary and the scraping devices 11 are movably guided against the filter 6 to scrape it.

It is also conceivable that this piston/cylinder unit 29 of FIG. 3 and FIG. 4 is used as a removal device 32. When a backflushing is carried out by the filter 6, wherein contaminants that have accumulated on the filter 6 are flushed back into the mass flow-way 12 between filter 6 and mass cylinder 13, these contaminants can be removed for example via the piston/cylinder unit 29, wherein in this embodiment example the removal device 32 formed as piston/cylinder unit 29 can, as it were, suck up the contaminants.

After contaminants have been removed by the piston/cylinder unit 29, they can be discharged from the piston/cylinder unit 29 to an environment by, for example, connecting the piston/cylinder unit 29 to the mass flow-way 12 and/or the environment via a corresponding valve circuit.

FIG. 8 shows a moulding machine 2 with a plasticizing unit 1, which can be formed for example corresponding to one of the embodiment variants shown above.

A moulding machine 2 is schematically represented in FIG. 8. This moulding machine 2 has a plasticizing unit 1 and a clamping unit 17, which are arranged on a machine frame 23.

The clamping unit 17 has a fixed moulding plate 19, a movable moulding plate 20 and an end plate 21.

In contrast to the horizontal three-plate machine represented, the clamping unit 17 could also be formed as a two-plate machine or a vertical machine.

The movable moulding plate 20 is movable relative to the machine frame 23 via a drive unit 22. A drive device 22 of this type can have for example a toggle clamp mechanism.

Mould halves of a moulding tool 18, which form a mould cavity 4 (represented by dashed lines), can be clamped or mounted on the fixed moulding plate 19 and the movable moulding plate 20.

The moulding tool 18, which is represented closed in FIG. 8, has at least one cavity 4. An injection channel, via which a plasticized mass can be fed to the plasticizing unit 1, leads to the cavity 4.

The plasticizing unit 1 has a plasticizing screw 3 arranged in an mass cylinder 13, which are formed for plasticizing a plasticizable material.

The mass flow 7 of plasticized material from the plasticizing unit 1 is then guided via the filter 6 to an injection unit 16, wherein the injection unit 16 has a degassing device 31, wherein the mass flow 7 of plasticized material can still be degassed by the degassing device 31 before being injected by the injection unit 16.

Following the degassing device 31 for degassing the plasticized material, the plasticized material is fed to the injection unit 16.

The injection unit 16 of this embodiment example has a further mass cylinder and an injection screw arranged in this mass cylinder. This injection screw is rotatable about its longitudinal axis as well as axially movable along the longitudinal axis in the injection direction.

These movements are injected via a schematically represented drive unit 15. The drive unit 15 preferably comprises a rotary drive for the rotary movement and a linear drive for the axial injection movement, as well as the drive unit 15 of the plasticizing unit 1.

The plasticizing unit is in signal-conducting connection with an open- or closed-loop control unit 9. The open- or closed-loop control unit 9 issues control commands to the plasticizing unit 1 as well as to the injection unit 16.

It can furthermore be provided that the open- or closed-loop control unit 9 is connected in a signal-conducting manner to a filter-changing device 8 in order to control or regulate the filter-changing device 8.

The open- or closed-loop control unit 9 can be connected to an operating unit or can be an integral component of such an operating unit.

### LIST OF REFERENCE NUMBERS

1 Plasticizing unit
2 Moulding machine
3 Plasticizing screw
4 Mould cavity
5 Screw axis
6 Filter
7 Mass flow
8 Filter-changing device
9 Open- or closed-loop control device
10 Manifold
11 Scraping device
12 Mass flow-way
13 Mass cylinder
14 Feed device
15 Drive unit
16 Injection unit
17 Clamping unit
18 Moulding tool
19 Fixed moulding plate
20 Movable moulding plate
21 End plate
22 Clamping mechanism
23 Machine frame
24 Band heater
25 Space in front of the screw
26 Actuator
27 Seal
28 Further manifold
29 Piston/cylinder unit
30 Shut-off valve
31 Degassing device
32 Removal device

1. A plasticizing unit for a moulding machine, the plasticizing unit comprising at least one plasticizing screw for plasticizing a plasticizable material and injecting it into at least one mould cavity, the least one plasticizing screw being rotationally and axially movable in relation to a screw axis; and at least one filter arranged downstream of the at least one plasticizing screw in a direction of flow of a mass flow of the plasticizable material.

2. The plasticizing unit according to claim 1, further comprising at least one actuator for conveying the plasticizable material against the direction of flow of the mass flow in order to effect a pressure relief of a pressure of the plasticizable material bearing on the at least one filter.

3. The plasticizing unit according to claim 2, wherein the at least one actuator is formed by the at least one plasticizing screw and/or by a piston/cylinder unit, preferably in the form of a melt accumulator.

4. The plasticizing unit according to claim 3, wherein the piston/cylinder unit is arranged fluidically between the at least one filter and the plasticizing screw, or is arranged fluidically after the at least one filter.

5. The plasticizing unit according to claim 1, further comprising a filter-changing device formed to move the at least one filter out of the mass flow of the plasticizable material by a first linear movement and/or rotary movement, and/or to move the at least one filter into the mass flow of the plasticizable material by a second linear movement and/or rotary movement.

6. The plasticizing unit according to claim 5, wherein the filter-changing device is formed as a slide-plate screen changer, piston screen changer, cassette screen changer and/or belt filter.

7. The plasticizing unit according to claim 2, further comprising an open- or closed-loop control unit for activating the actuator and the filter-changing device, the open- or closed-loop control device being formed to activate the actuator to pull back against a direction of flow of the plasticizable material in order to effect a pressure relief of a pressure of the plasticizable material bearing on the at least one filter and/or to effect a backflushing of the at least one filter.

8. The plasticizing unit according to claim 7, wherein the open- or closed-loop control unit is formed to activate the filter-changing device during the pressure relief to move the at least one filter out of the mass flow of the plasticizable material and/or to move the at least one filter into the mass flow of the plasticizable material.

9. The plasticizing unit according to claim 1, further comprising at least one removal device with which plasticizable material present between at least one plasticizing screw and at least one filter is at least partially removable.

10. The plasticizing unit according to claim 9, wherein the at least one removal device has at least one discharge screw, at least one piston/cylinder unit and/or at least one outlet valve.

11. The plasticizing unit according to claim 7, wherein the open- or closed-loop control unit is formed to remove plasticizable material present between the at least one filter and the at least one plasticizing screw during the pressure relief by activating at least one removal device.

12. The plasticizing unit according to claim 1, wherein a manifold—preferably a pressure manifold—is arranged after the at least one plasticizing screw and before the at least one filter in a direction of flow of the mass flow of the plasticizable material.

13. The plasticizing unit according to claim 1, wherein the at least one filter has a screen and/or a woven fabric and/or a perforated filter unit.

14. The plasticizing unit according to claim 1, further comprising at least one scraping device for scraping the at least one filter.

15. The plasticizing unit according to claim 1, further comprising at least one seal for sealing the at least one filter against the environment.

16. The plasticizing unit according to claim 1, further comprising at least one dosing device for additives—preferably at least one gas injector—arranged before the at least one filter in a direction of flow of the mass flow of the plasticizable material.

17. A moulding machine comprising the plasticizing unit according to claim 1.

18. A method of operating the plasticizing unit according to claim 1, wherein a plasticizable material is plasticized by a rotating movement of the at least one plasticizing screw in relation to the screw axis, and the plasticizable material is injected into the at least one mould cavity by an axial movement of the at least one plasticizing screw in relation to the screw axis, wherein the mass flow of the plasticizable material is filtered with the aid of at least one filter, which is arranged downstream of the at least one plasticizing screw in a direction of flow of a mass flow of the plasticizable material.

19. The method according to claim 18, wherein the mass flow of the plasticizable material is conveyed against the direction of flow by means of at least one actuator—preferably the at least one plasticizing screw—and thus a pressure relief of a pressure of the plasticizable material bearing on the at least one filter is effected.

20. The method according to claim 19, wherein the at least one filter is moved out of and/or into the mass flow of the plasticizable material via a filter-changing device during the pressure relief.
